(19) United States
(12) Patent Application Publication
(10) Pub. No.: US 2012/0275109 A1
(43) Pub. Date: Nov. 1, 2012

(54) ELECTRONIC DEVICE WITH EMI SHIELDING HEAT DISSIPATION MEMBER

(75) Inventors: WEI-CHENG CHENG, Tu-Cheng (TW); CHIH-HANG CHAO, Tu-Cheng (TW)

(73) Assignee: HON HAI PRECISION INDUSTRY CO., LTD., Tu-Cheng (TW)

(21) Appl. No.: 13/277,221

(22) Filed: Oct. 20, 2011

(30) Foreign Application Priority Data
Apr. 26, 2011 (TW) 100114528

(51) Int. Cl. G06F 1/20

(52) U.S. Cl. 361/679.54

(57) ABSTRACT

An electronic device include a metal chassis, a motherboard within the metal chassis, a central processing unit (CPU) socket attached on the motherboard, a CPU attached to the CPU socket, a heat dissipation pad attached on the CPU, and a metal heat dissipation member. The metal heat dissipation member is attached on the heat dissipation pad to transfer heat from the CPU and abuts the metal chassis to provide electro magnetic interference (EMI) shielding for the CPU.

### BACKGROUND

1. Technical Field

The present disclosure relates to an electronic device with electro magnetic interference (EMI) shielding heat dissipation member.

2. Description of Related Art

Portable electronic devices, such as portable computers, are becoming smaller and thinner. Thus, there is less space in the portable electronic devices to accommodate conventional heat sinks and fans, and the task of removing the heat generated by these electronic devices becomes more difficult. Many electronic devices include at least one heat generating component (e.g., a CPU) and a metal heat dissipating plate attached on the heat generating component. The metal heat dissipating plate is often larger than the heat generating component, thereby enhancing the heat dissipation effect. However, the metal heat dissipating plate is generally limited to dissipating heat from the heat generating component, but does not provide protection against EMI.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a partial, cross sectional view of a first embodiment of an electronic device.

FIG. 2 is a partial, cross sectional view of a second embodiment of an electronic device.

FIG. 3 is a partial, cross sectional view of a third embodiment of an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

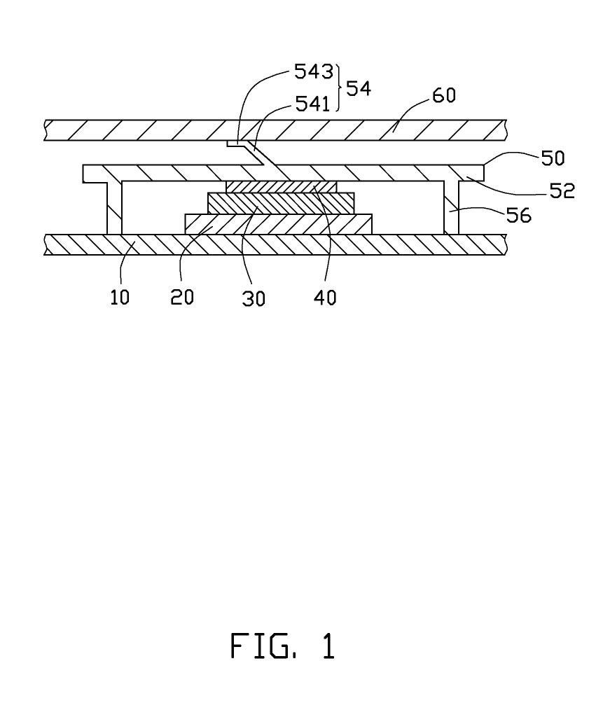

Referring to FIG. 1, a first embodiment of an electronic device includes a motherboard 10, a CPU socket 20 attached on top of the motherboard 10, a CPU 30 attached on the CPU socket 20, a heat dissipation pad 40 attached on the CPU 30, a first heat dissipation member 50 attached on the heat dissipation pad 40, and a metal chassis 60 of the electronic device. The heat dissipation pad 40 is made from thermally-conductive materials such as grease, metal, or a mixture of thermal grease and metal particles. The metal and particles thereof can be aluminum, copper, silver, or the like. In one embodiment, the electronic device is a portable computer.

The first heat dissipation member 50 includes a first metal plate 52, a resilient piece 54, as a protrusion, extending from the top of the first metal plate 52, and a pair of first supporting legs 56 perpendicularly extending from the underside of the first metal plate 52. The CPU 30 is located between the pair of first supporting legs 56. The resilient piece 54 includes a slanting portion 541 obliquely and upwardly extending from the first metal plate 52 and a horizontal portion 543 extending from the distal end of the slanting portion 541. The horizontal portion 543 and the first metal plate 52 are both parallel to the motherboard 10. The horizontal portion 543 abuts the inside of the metal chassis 60. The pair of first supporting legs 56 are perpendicular to the motherboard 10 and rest on the motherboard 10, thereby reducing the weight or other force applied to the CPU 30 by the first heat dissipation member 50. The height of each of the pair of first supporting legs 56 is substantially equal to the total thickness of the CPU socket 20, the CPU 30, and the heat dissipation pad 40. In one embodiment, the metal chassis 60 is connected to ground. The resilient piece 54 abutting the metal chassis 60 can be grounded, thereby providing shielding against EMI for the CPU 30.

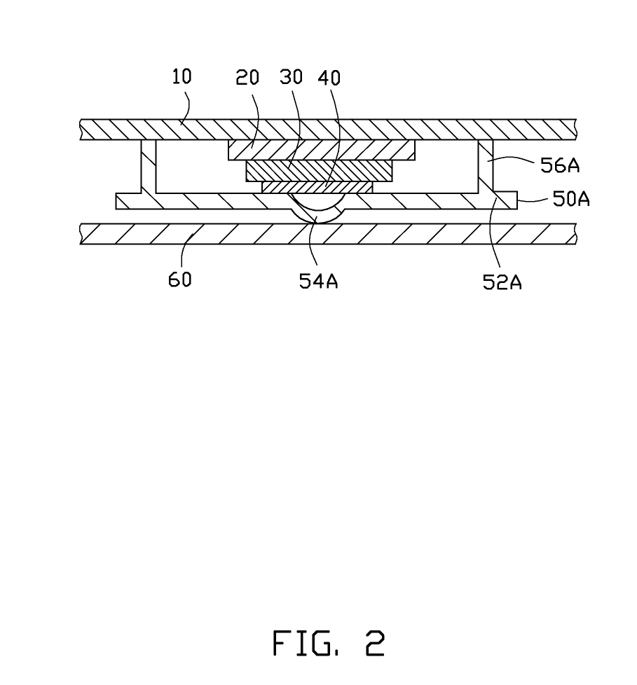

Referring to FIG. 2, in a second embodiment, the CPU socket 20, the CPU 30, and the heat dissipation pad 40 are attached to the bottom of the motherboard 10. A second heat dissipation member 50A is attached to the underside of the motherboard 10. The second heat dissipation member 50A includes a second metal plate 52A, a round protrusion or nub (arcuate resisting piece 54A) protruding downwards from the metal plate 52A, and a pair of second supporting legs 56A perpendicularly and upwardly extending from the second metal plate 52A. The second metal plate 52A abuts the heat dissipation pad 40. The arcuate resisting piece 54A abuts the metal chassis 60 to provide EMI shielding to the CPU 30.

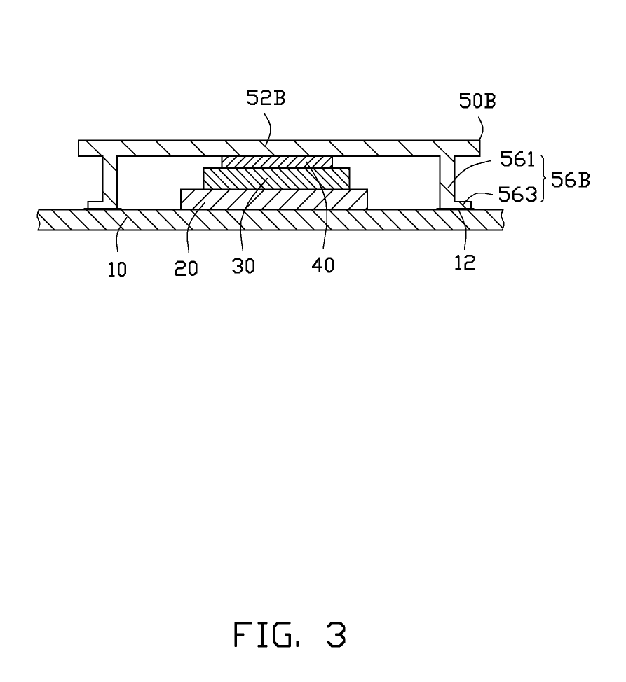

Referring to FIG. 3, in a third embodiment, a grounding pad 12 is attached on the motherboard 10. A third heat dissipation member 50B includes a third metal plate 52B, and a pair of third supporting legs 56B extending downwards from the third metal plate 52B. Each of the pair of third supporting legs 56B includes a vertical portion 561 and a flange 563 perpendicularly extending from a lower end of the vertical portion 561. The flanges 563 of the pair of third supporting legs 56B rest on the grounding pad 12 on the motherboard 10 to provide EMI shielding for the CPU 30.

In the embodiments, all of the heat dissipation members 50, 50A, and 50B are metallic or made from metal and larger than the CPU 30, thereby transferring heat from the CPU 30 quickly.

While the present disclosure has been illustrated in detail in one or more embodiments, it is not intended to restrict or in any way limit the scope of the appended claims to such detail. Additional advantages and modifications within the spirit and scope of the present disclosure will readily appear to those skilled in the art, and the present disclosure is not to be limited to the specific details and illustrative examples shown and described.

What is claimed is:

1. An electronic device comprising:
a metal chassis;
a motherboard shielded by the metal chassis;
a central processing unit (CPU) socket attached on the motherboard;
a CPU attached to the CPU socket;
a heat dissipation pad attached on the CPU; and
a metal heat dissipation member, attached on the heat dissipation pad to transfer heat from the CPU, and abutting against the metal chassis to provide electro magnetic interference (EMI) shielding for the CPU.

2. The electronic device of claim 1, wherein the metal heat dissipation member comprises a metal plate abutting on the heating dissipation pad and a resilient piece extending from the metal plate, and the resilient piece abuts against the metal chassis.

3. The electronic device of claim 2, wherein the resilient piece comprises a slanting portion obliquely extending from the metal plate and a horizontal portion abutting against the metal chassis.

4. The electronic device of claim 3, wherein the metal plate and the horizontal portion are both parallel to the motherboard, and the slanting portion is oriented obliquely relative to the motherboard.

5. The electronic device of claim 4, wherein the metal heat dissipation member further comprises a pair of supporting legs extending from the metal plate and abutting the motherboard.

6. The electronic device of claim 5, wherein a pair of grounding pads is attached on the motherboard, the pair of supporting legs abuts the pair of grounding pads to provide EMI shielding for the CPU.

7. The electronic device of claim 6, wherein each of the pair of supporting legs comprises a vertical portion perpendicular to the motherboard and a flange perpendicularly extending from the vertical portion, the flange abuts one of the pair of grounding pads.

8. The electronic device of claim 5, wherein a height of the supporting legs is substantially equal to a total thickness of the CPU socket, the CPU, and the heat dissipation pad.

9. The electronic device of claim 2, wherein the resilient piece has an arc shape.

10. The electronic device of claim 1, wherein the heat dissipation pad is made from thermal grease, metal, or mixture of thermal grease and metal particles.

11. An electronic device comprising:
a metal chassis;
a motherboard shielded by the metal chassis;
a central processing unit (CPU) attached on the motherboard; and
a metal heat dissipation member comprising a metal plate attached on the CPU to transfer heat from the CPU and a resilient piece protruding from the metal plate, wherein the resilient piece abuts against the metal chassis to provide electro magnetic interference (EMI) shielding for the CPU.

12. The electronic device of claim 11, wherein the resilient piece comprises a slanting portion obliquely extending from the metal plate and a horizontal portion abutting against the metal chassis, and the CPU is attached to a front side of the motherboard.

13. The electronic device of claim 12, wherein the metal plate and the horizontal portion are both parallel to the motherboard, and the slanting portion is oriented obliquely relative to the motherboard.

14. The electronic device of claim 13, wherein the metal heat dissipation member further comprises a pair of supporting legs extending from the metal plate and abutting the motherboard.

15. The electronic device of claim 14, wherein a pair of grounding pads is attached on the motherboard, the pair of supporting legs abuts the pair of grounding pads.

16. The electronic device of claim 15, wherein each of the pair of supporting legs comprises a vertical portion perpendicular to the motherboard and a flange perpendicularly extending from the vertical portion, the flange abuts one of the pair of grounding pads.

17. The electronic device of claim 11, wherein the resilient piece has an arc shape, the CPU is attached to a rear side of the motherboard.

18. The electronic device of claim 14, further comprising a CPU socket attached on the motherboard, wherein the CPU is attached to the CPU socket, and the CPU socket is located between the motherboard and the CPU.

19. The electronic device of claim 18, further comprising a heat dissipation pad attached on the motherboard and located between the CPU and the metal plate, wherein the heat dissipation pad is made from thermal grease, metal, or mixture of thermal grease and metal particle.

20. The electronic device of claim 19, where a height of each of the pair of supporting legs is substantially equal to a total thickness of the CPU socket, the CPU, and the heat dissipation pad.
